(19) United States
(12) Patent Application Publication
(10) Pub. No.: US 2024/0416911 A1
(43) Pub. Date: Dec. 19, 2024

(54) METHOD AND DEVICE FOR THE LONGITUDINAL CONTROL OF A VEHICLE

(71) Applicants: Mercedes-Benz Group AG, Stuttgart (DE); Robert Bosch GmbH, Stuttgart (DE)

(72) Inventors: Goran HUSKIC, Stuttgart (DE); Atta OVEISI, Fellbach (DE); Alexander FÜRSICH, Stuttgart (DE); Thomas ROTHERMEL, Renningen (DE); Klaus-Peter KUHN, Hochdorf (DE); Peter BOESCH, Leonberg (DE); André KEMPF, Stuttgart (DE)

(21) Appl. No.: 18/714,119

(22) PCT Filed: Nov. 15, 2022
(86) PCT No.: PCT/EP2022/081896

§ 371 Date: May 29, 2024

(30) Foreign Application Priority Data
Nov. 30, 2021 (DE) 10 2021 213 486.6

(51) Int. Cl. B60W 30/14

(52) U.S. Cl. CPC B60W 30/146; B60W 2520/10; B60W 2520/105; B60W 2552/30; B60W 2710/18; B60W 2720/106

(57) ABSTRACT

A method and device for longitudinal control of a vehicle as a function of a target trajectory, which specifies a series of target positions to be assumed by the vehicle over time. A controller actuating acceleration for trajectory control is determined based on an actual state of the vehicle. When the vehicle is following the target trajectory, a curvature of the target trajectory at a current position of the vehicle is determined from a local course of the target trajectory. Furthermore, when the vehicle is following the target trajectory, a longitudinal acceleration resulting from the target trajectory is determined as the current trajectory acceleration at the current position of the vehicle and the controller actuating acceleration is limited to a value that corresponds at most to a sum of the current trajectory acceleration and the acceleration offset. The vehicle is accelerated in accordance with the limited controller actuating acceleration.

The invention relates to a method for the longitudinal control of a vehicle.

The invention also relates to a device for the longitudinal control of a vehicle.

DE 10 2017 010 180 B3 discloses a device and a method for controlling a longitudinal position of a vehicle by means of a longitudinal position controller which generates a longitudinal acceleration control signal for a subordinate acceleration control unit from a longitudinal dynamic pre-control setpoint variable and longitudinal dynamic control error variables. A current control reference point corresponding to a current point in time and a preceding control reference point corresponding to a predeterminable look-ahead point in time are determined as control-relevant points in time. For each of the control reference points, current or predicted actual/target deviations of a longitudinal position, a driving speed and an acceleration are determined and used as the basis for forming the longitudinal dynamic control error variables. Furthermore, target acceleration values are determined for each of the control reference points and used as the basis for forming the longitudinal dynamic pre-control target value. The longitudinal dynamic pre-control setpoint is formed by summing the acceleration setpoints determined for the control reference points in a weighted manner.

The object of the invention is to provide a novel method and a novel device for the longitudinal control of a vehicle.

According to the invention, the problem is solved by a method having the features specified in claim 1 and by a device having the features specified in claim 7. Advantageous embodiments of the invention are the subject of the subclaims.

In the method according to the invention for longitudinal control of a vehicle as a function of a target trajectory, which specifies a series of target positions to be assumed by the vehicle over time, a controller actuating acceleration for trajectory control is determined based on an actual state of the vehicle, by means of which the vehicle is to be accelerated in accordance with specifications of the target trajectory. When the vehicle is following the target trajectory, a curvature of the target trajectory at a current position of the vehicle is determined from a local course of the target trajectory, whereby an acceleration offset that decreases with increasing curvature is determined on the basis of the curvature. Furthermore, when the vehicle is following the target trajectory, a longitudinal acceleration resulting from the target trajectory is determined as the current trajectory acceleration at the current position of the vehicle. The controller actuating acceleration is limited to a value that corresponds at most to a sum of the current trajectory acceleration and the acceleration offset, and the vehicle is accelerated in accordance with the limited controller actuating acceleration.

Trajectory control of an automated, in particular highly automated or autonomously driving vehicle, is a fundamental prerequisite for realizing the automated driving function. This involves deciding which actions the vehicle should perform in the future based on data from an environment detection system. The result of this decision is a trajectory which, for example, maps the position of the vehicle on a road over time and serves as a movement reference in a known vehicle environment. The trajectory control is intended to follow the trajectory as accurately as possible. If, for any reason, a major longitudinal position control error has built up, a trajectory specification at the target position does not correspond to a trajectory specification at an actual position on the road at which the vehicle is currently located. This means that a “target time” continues to run. There is a risk that the vehicle is in a tight bend, for example, and accelerates automatically because a temporal reference point, i.e. the target position, is already further ahead in the trajectory, for example on a straight line following the bend.

In this method, a discrepancy between the local reference point, i.e. the actual position of the vehicle, and the temporal reference point, i.e. the target position of the vehicle in the trajectory, is taken into account in the longitudinal control of the vehicle. The method is used to limit a target acceleration specification if it is too high at the actual position. With such a curvature-dependent acceleration limitation at the actual position, dangerous situations resulting from excessive acceleration can be prevented, for example excessive acceleration in a tight bend.

In other words, the method enables safe trajectory control with the aim of reaching a planned position at an associated time, whereby, if necessary, the acceleration at the actual position is limited by a curvature-dependent acceleration limit below the value of the acceleration specification at the target position.

In one possible embodiment of the method, the actual state of the vehicle is formed from at least an actual speed of the vehicle, an actual acceleration of the vehicle and/or an actual position of the vehicle. The actual state can be easily depicted using these variables, so that the controller actuating acceleration can be reliably determined.

In a further possible embodiment of the method, an actual position or a next target position from the series of target positions is used as the current position of the vehicle. This enables the current position of the vehicle to be determined easily and with sufficient accuracy to determine the curvature.

In a further possible embodiment of the method, the longitudinal acceleration resulting from the target trajectory is determined from a temporal change in distances between successive target positions of the target trajectory. This makes it easy to determine the current trajectory acceleration.

In a further possible embodiment of the method, the target trajectory is fed to a trajectory controller, by means of which the vehicle is to be accelerated according to the specifications of the target trajectory using the controller actuating acceleration. The limited controller actuating acceleration is fed to an acceleration control unit which is subordinate to the trajectory controller and which controls and/or regulates a real acceleration of the vehicle.

In a further possible embodiment of the method, if a predetermined difference between the predetermined controller actuating acceleration and the limited controller actuating acceleration is exceeded, the target trajectory is recalculated. In this way, a deviation of the target trajectory from an actual trajectory and, as a result, a deviation of the controller actuating acceleration from the corrected controller actuating acceleration can be minimized.

The device according to the invention for longitudinal control of a vehicle as a function of a target trajectory, which specifies a series of target positions to be assumed by the vehicle over time, comprises a trajectory controller, which uses a target trajectory supplied to it to determine a controller actuating acceleration for trajectory control based on an actual state of the vehicle, by means of which the vehicle is to be accelerated in accordance with specifications of the target trajectory. The device also comprises a pre-processing unit, which determines a curvature of the target trajectory at a current position of the vehicle from a local course of the target trajectory when the vehicle is following the target trajectory. Furthermore, the pre-processing unit uses the curvature to determine an acceleration offset that decreases with increasing curvature and, when the vehicle is following the target trajectory, a longitudinal acceleration resulting from the target trajectory is determined as the current trajectory acceleration at the current position of the vehicle. In addition, the device comprises a limiting unit which limits the controller actuating acceleration to a value which corresponds at most to a sum of the current trajectory acceleration and the acceleration offset, as well as an acceleration control unit which is subordinate to the trajectory controller and which accelerates the vehicle in accordance with the limited controller actuating acceleration.

By means of the device, a discrepancy between the local reference point, i.e. the actual position of the vehicle, and the temporal reference point, i.e. the target position of the vehicle in the trajectory, can be taken into account in the longitudinal control of the vehicle.

The device limits a target acceleration specification if it is too high at the actual position. With such a curvature-dependent acceleration limitation at the actual position, dangerous situations resulting from excessive acceleration can be prevented, for example excessive acceleration in a tight bend.

In other words, the device enables safe trajectory control with the aim of reaching a planned position at an associated time, whereby, if necessary, the acceleration at the actual position is limited by a curvature-dependent acceleration limit below the value of the acceleration specification at the target position.

In one possible embodiment of the device, the acceleration control unit is a vehicle braking system. This can be used to set the limited controller control acceleration simply and reliably.

In a further possible embodiment of the device, it comprises a control error monitoring unit which recalculates the target trajectory if a predefined difference between the predefined controller actuating acceleration and the limited controller actuating acceleration is exceeded. In this way, a deviation of the target trajectory from an actual trajectory and, as a result, a deviation of the controller actuating acceleration from the corrected controller actuating acceleration can be minimized.

Examples of embodiments of the invention are explained in more detail below with reference to drawings.

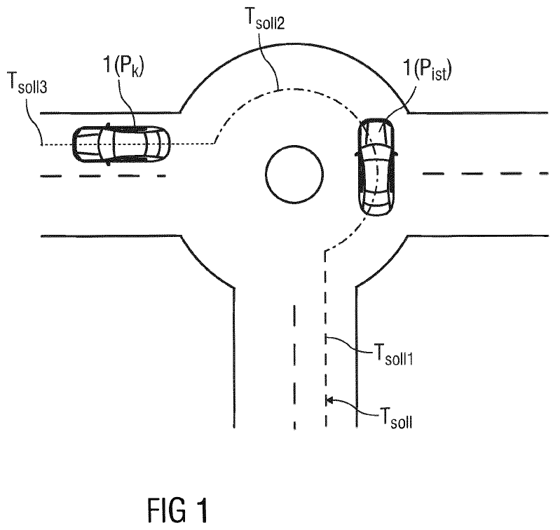

FIG. 1 is a schematic top view of a traffic situation with a vehicle in an actual position and a target position,

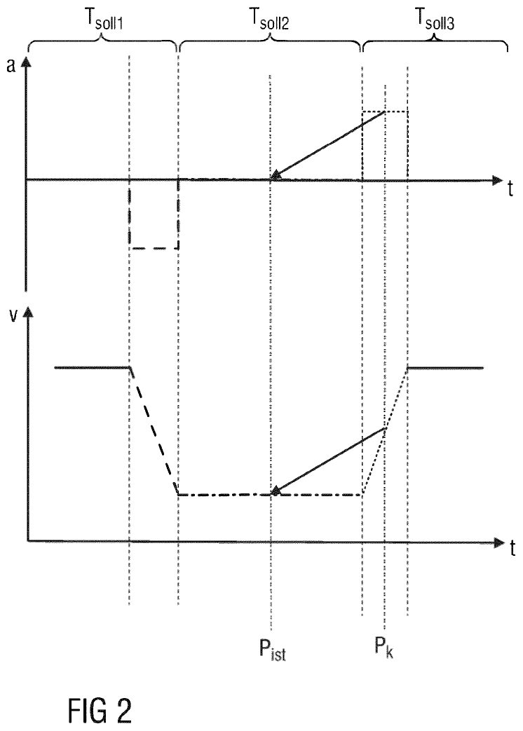

FIG. 2 shows schematic diagrams of the acceleration and speed of a vehicle over time,

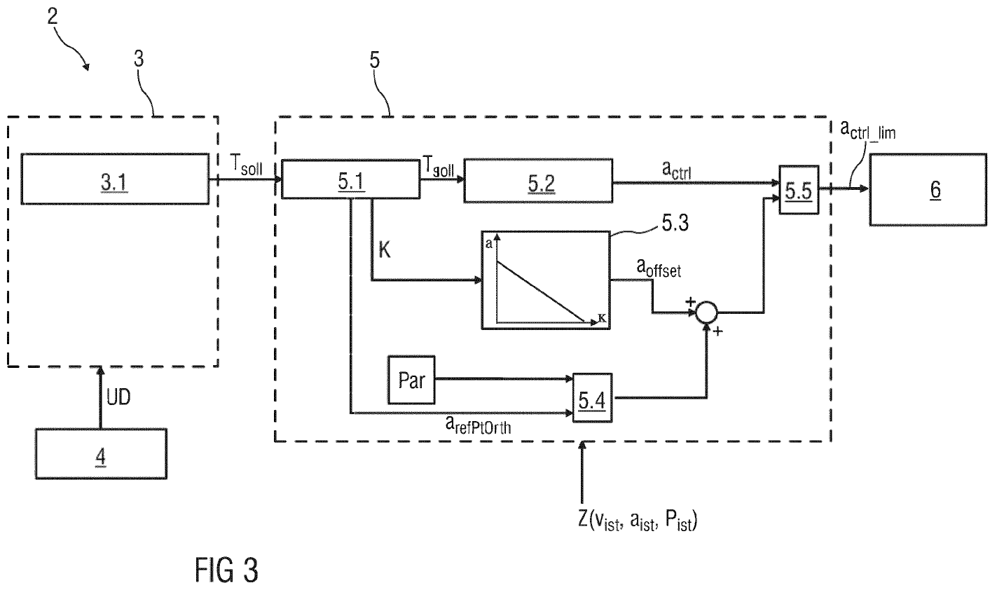

FIG. 3 is a schematic block diagram of a device for longitudinal control of a vehicle, and

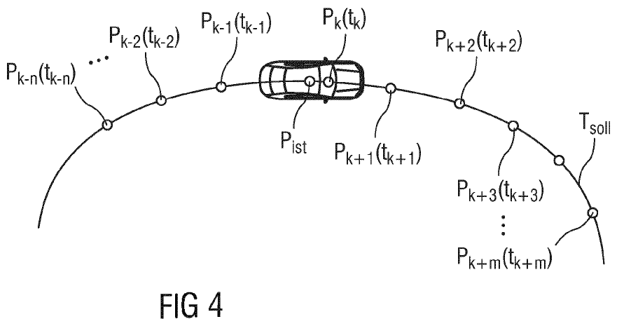

FIG. 4 is a schematic view of the course of a target trajectory of a vehicle.

Corresponding parts are marked with the same reference signs in all figures.

FIG. 1 is a top view of a traffic situation with a vehicle 1 in an actual position Pᵢₛₜ and a target position Pₖ as well as a target trajectory Tₛₒₗₗ with several trajectory sections Tₛₒₗₗ₁ to Tₛₒₗₗ₃. FIG. 2 shows curves of an acceleration a and a speed v of the vehicle 1 according to FIG. 1 as a function of the time t.

The vehicle 1 is designed for automated, in particular highly automated or autonomous driving. Trajectory control is a fundamental prerequisite for the realization of such an automated driving function.

In this trajectory control, a decision is made on which actions the vehicle 1 should perform in the future based on data UD from an environment detection system shown in more detail in FIG. 3. The result of this decision is the target trajectory Tₛₒₗₗ, which, for example, represents a position of the vehicle 1 on a roadway over the time t and serves as a movement reference in a known vehicle environment. The trajectory control is 25 intended to follow the trajectory as accurately as possible. If, for any reason, a major longitudinal position control error has built up, a trajectory specification at the target position Pₖ does not correspond to a trajectory specification at the actual position Pᵢₛₜ on the road at which the vehicle 1 is currently located. This means that a “target time” continues to run.

Using a traffic circle as an example, the illustration shows that the actual position Pᵢₛₜ of the automated vehicle 1 is behind the target position Pₖ. The actual position Pᵢₛₜ is located in the traffic circle, while the target position Pₖ is already outside the traffic circle after leaving it.

As FIG. 2 shows, according to the speed profile assigned to the target trajectory Tₛₒₗₗ and the acceleration profile, it is intended that the vehicle 1 should travel at a low constant speed v within the traffic circle on the trajectory section Tₛₒₗₗ₂ and accelerate more strongly on the trajectory section Tₛₒₗₗ₃ after the traffic circle until a higher speed v is reached. The acceleration profile intended for the trajectory section Tₛₒₗₗ₃ is not suitable for use with a road geometry in the trajectory section Tₛₒₗₗ₂.

However, since, as shown in FIG. 1, the temporal reference point, i.e. the target position Pₖ in the trajectory section Tₛₒₗₗ₃, and the local reference point, i.e. the actual position Pᵢₛₜ in the trajectory section Tₛₒₗₗ₂, are far apart, there is a risk that the vehicle 1 is located within the traffic circle on the trajectory section Tₛₒₗₗ₂ and accelerates automatically because the temporal reference point is already further ahead, in this case on a straight line following the traffic circle in the trajectory section Tₛₒₗₗ₃.

In this situation, a typical trajectory controller would attempt to compensate for a longitudinal position error and vehicle 1 would accelerate faster in the traffic circle. Depending on how large a curvature K is in the route, such a situation is generally undesirable and potentially dangerous.

Such errors can also occur if a so-called control error monitoring module is present in the system for the automated operation of the vehicle 1, which reschedules the target trajectory Tₛₒₗₗ if a control error becomes larger. This is the case, for example, if the control error is relatively large but lies below a defined threshold for redefining the target trajectory T soll.

If, however, the actual position Pᵢₛₜ is still in the trajectory section Tₛₒₗₗ₁ instead of the trajectory section Tₛₒₗₗ₂, and the vehicle 1 is still decelerating, this does not result in a safety-relevant problem. In this case, the control error would increase even more, but without undesirable acceleration a.

FIG. 3 shows a block diagram of a device 2 for longitudinal control of a vehicle 1.

The device 2 comprises a first computing unit 3 with a trajectory planning module 3.1, which plans the target trajectory Tₛₒₗₗ on the basis of data UD recorded by means of an environment detection sensor 4.

In order to solve the problem illustrated in FIGS. 1 and 2, where a deviation of the actual position Pᵢₛₜ from the target position Pₖ results in unadjusted accelerations a of the vehicle 1 in automated driving mode, the target trajectory Tₛₒₗₗ is fed to a further computing unit 5 with a pre-processing module 5.1, a trajectory controller 5.2, a characteristic curve 5.3, a maximum value detector 5.4 and a limiting unit 5.5.

When the vehicle 1 is following the target trajectory Tₛₒₗₗ, the pre-processing module 5.1 derives a curvature K of the target trajectory Tₛₒₗₗ at a current position of the vehicle 1 from a local course of the target trajectory Tₛₒₗₗ.

Using the characteristic curve 5.3, which represents the acceleration a of the vehicle 1 as a function of the curvature K, the pre-processing module 5.1 determines an acceleration offset a_{offset} that decreases with increasing curvature K as a function of the curvature K and, in particular, using predicted future information. This acceleration offset a_{offset} can also be formed as a function of a friction value of a road surface and forms a permissible acceleration deviation.

Furthermore, when the vehicle 1 is following the target trajectory Tₛₒₗₗ, the pre-processing module 5.1 determines a longitudinal acceleration resulting from the target trajectory Tₛₒₗₗ as the current trajectory acceleration a_{refPtOrth} at a current position of the vehicle 1, for example the actual position Pᵢₛₜ, and feeds it to the limiting unit 5.5. This trajectory acceleration a_{refPtOrth} forms a reference acceleration at a trajectory point closest to the current position of the vehicle 1.

In contrast to the actual position Pᵢₛₜ of the vehicle 1, a next target position Pₖ from a series of target positions Pₖ₋ₙ to Pₖ₊ₘ of the target trajectory Tₛₒₗₗ shown in more detail in FIG. 4 can also be used as the current position of the vehicle 1.

The longitudinal acceleration resulting from the target trajectory Tₛₒₗₗ can be determined from a temporal change in distances between successive target positions Pₖ₋ₙ to Pₖ₊ₘ Of the target trajectory Tₛₒₗₗ shown in more detail in FIG. 4.

The acceleration offset a_{offset} and the trajectory acceleration a_{refPtOrth} are added together, whereby a sum formed is also fed to the limiting unit 5.5.

Furthermore, the trajectory controller 5.2 uses the target trajectory Tₛₒₗₗ supplied to it to determine a controller actuating acceleration a_{ctrl} for trajectory control based on an actual state Z of the vehicle 1, by means of which the vehicle 1 is to be accelerated in accordance with specifications of the target trajectory Tₛₒₗₗ. The actual state Z of the vehicle 1 is characterized, for example, by an actual speed vᵢₛₜ, an actual acceleration aᵢₛₜ and the actual position Pᵢₛₜ of the vehicle 1.

By means of the limiting unit 5.5, the minimum of the sum of the acceleration offset a_{offset} and the trajectory acceleration a_{refPtOrth} and the actuating acceleration a_{ctrl} is used to calculate a limited controller actuating acceleration a_{ctrl_lim} in accordance with

$${a}_{ctrl \_ lim} = min ( {a}_{ctrl} , max ( Par , {a}_{refPtOrth} ) + {a}_{offset} ) \qquad ( 1 )$$

determined.

Only trajectory accelerations a_{refPtOrth} that are greater than a positive parameter Par are taken into account, as otherwise the vehicle 1 would come to a standstill in a deceleration phase. In this case, a negative trajectory acceleration a_{refPtOrth} is always smaller than a positive controller actuating acceleration a_{ctrl} in a subsequent acceleration phase.

The limited controller actuating acceleration a_{ctrl_lim} is fed to an acceleration control unit 6, which is subordinate to the trajectory controller 5.2 and accelerates the vehicle 1 in accordance with the limited controller actuating acceleration a_{ctrl_lim}. The acceleration control unit 6 is, for example, a vehicle braking system. In this way, the control system output is never greater than the local trajectory acceleration a_{refPtOrth}, offset upwards by a permissible curvature-dependent deviation.

It is therefore possible that the vehicle 1 would not accelerate undesirably strongly at the actual position Pᵢₛₜ in the situation shown in FIG. 1. On a straight stretch of road, on the other hand, vehicle 1 can accelerate sufficiently strongly and compensate for a control error.

FIG. 4 shows a course of a possible target trajectory Tₛₒₗₗ of a vehicle 1. The target trajectory Tₛₒₗₗ specifies a series of target positions Pₖ₋ₙ to Pₖ₊ₘ to be assumed by the vehicle 1 over the time t at respective points in time tₖ₋ₙ to tₖ₊ₘ.

### LIST OF REFERENCE NUMBERS

1 vehicle
2 device
3 computing unit
3.1 trajectory planning module
4 environment detection sensor system
5 computing unit
5.1 processing module
5.2 trajectory controller
5.3 characteristic curve
5.4 maximum value detector
5.5′ limiting unit
6 acceleration control unit
a acceleration
a_{ctrl} controller actuating acceleration
a_{ctrl_lim} limited controller actuating acceleration
aᵢₛₜ actual acceleration
a_{offset} acceleration offset
a_{refPtOrth} trajectory acceleration
K curvature
Par parameter
Pᵢₛₜ actual position
Pₖ₋ₙ to Pₖ₊ₘ target position
t time
tₖ₋ₙ to tₖ₊ₘ point in time
Tₛₒₗₗ target trajectory
Tₛₒₗₗ₁ to Tₛₒₗₗ₃ trajectory section
UD data
v speed
vᵢₛₜ actual speed
Z actual state

1-9. (canceled)

10. A method for longitudinal control of a vehicle as a function of a target trajectory which specifies a series of target positions to be assumed by the vehicle over time, wherein
based on an actual state of the vehicle, a controller actuating acceleration for trajectory control, by means of which the vehicle is to be accelerated in accordance with specifications of the target trajectory, is determined,
when the vehicle is following the target trajectory, a curvature of the target trajectory at a current position of the vehicle is determined from a local course of the target trajectory,
an acceleration offset that decreases with increasing curvature is determined on the basis of the curvature,
when the vehicle is following the target trajectory, a longitudinal acceleration resulting from the target trajectory is determined as a current trajectory acceleration at the current position of the vehicle,
a controller actuating acceleration is limited to a value that corresponds at most to a sum of the current trajectory acceleration and the acceleration offset, and
the vehicle is accelerated in accordance with the limited controller actuating acceleration.

11. The method according to claim 10, wherein the actual state of the vehicle is formed at least from an actual speed, an actual acceleration and/or an actual position of the vehicle.

12. The method according to claim 10, wherein an actual position or a next target position from the series of target positions is used as the current position of the vehicle.

13. The method according to claim 10, wherein the longitudinal acceleration resulting from the target trajectory is determined from a temporal change of distances between successive target positions of the target trajectory.

14. The method according to claim 10, wherein
the target trajectory is fed to a trajectory controller, by means of which the vehicle is to be accelerated in accordance with the specifications of the target trajectory using the controller actuating acceleration, and
the limited controller actuating acceleration is fed to an acceleration control unit which is subordinate to the trajectory controller and which controls and/or regulates a real acceleration of the vehicle.

15. The method according to claim 10, wherein if a predetermined difference between the predetermined controller actuating acceleration and the limited controller actuating acceleration is exceeded, a recalculation of the target trajectory is carried out.

16. A device for longitudinal control of a vehicle as a function of a target trajectory, which specifies a series of target positions to be assumed by the vehicle over time, wherein
a trajectory controller is provided, which uses a target trajectory supplied to it to determine a controller actuating acceleration for trajectory control based on an actual state of the vehicle, by means of which the vehicle is to be accelerated in accordance with specifications of the target trajectory,
a pre-processing unit is provided, which
when the vehicle is following the target trajectory, determines a curvature of the target trajectory at a current position of the vehicle from a local course of the target trajectory,
determines an acceleration offset that decreases with increasing curvature on the basis of the curvature, and
when the vehicle is following the target trajectory, determines a longitudinal acceleration resulting from the target trajectory as the current trajectory acceleration at the current position of the vehicle,
a limiting unit is provided which limits the controller actuating acceleration to a value which corresponds at most to a sum of the current trajectory acceleration and acceleration offset,
an acceleration control unit subordinate to the trajectory controller is provided, which accelerates the vehicle in accordance with the limited controller actuating acceleration.

17. The device according to claim 16, wherein the acceleration control unit is a vehicle braking system.

18. The device according to claim 16, comprising a control error monitoring unit which, if a predetermined difference between the predetermined controller actuating acceleration and the limited controller actuating acceleration is exceeded, performs a recalculation of the target trajectory.
